(19) United States
(12) Patent Application Publication
(10) Pub. No.: US 2024/0122405 A1
(43) Pub. Date: Apr. 18, 2024

(54) Grilling Utensils

(71) Applicant: Steven J. Schoettle, Saint Simons Island, GA (US)

(72) Inventor: Steven J. Schoettle, Saint Simons Island, GA (US)

(21) Appl. No.: 17/432,833

(22) PCT Filed: Aug. 1, 2021
(86) PCT No.: PCT/US2021/044105

§ 371 Date: Aug. 20, 2021

(51) Int. Cl. A47J 37/07; A23L 5/10; A47J 43/18

(52) U.S. Cl. CPC A47J 37/0786; A23L 5/15; A47J 43/18

(57) ABSTRACT

A freezer-to-fire “brick” or “puck” is made of solid aluminum. These are each formed from a rectangular solid or an upright cylinder, respectively, with a cavity molded into one end of each. Holes are provided in each for ease of handling. A specialized handle is provided for engaging the holes. The invention also includes methods for using the brick, puck, and specialized handle.

### CROSS-REFERENCES TO RELATED APPLICATIONS

None.

### BACKGROUND OF INVENTION

### Field of the Invention

This invention is in the fields of heat exchange and heat storage, and more specifically in the fields of cooling, freezing, thawing, shaping, handling, and cooking or grilling of foodstuffs.

### Description of the Related Art

Refrigeration has made ice and freezer space available worldwide. In the late 20^{th} century, frozen ice substitutes enclosed in plastic have been used to keep foodstuffs and beverages cold in insulated coolers. Typically they consist of non-toxic compounds mixed with water to increase the heat of fusion of water and/or keep the water in a gel-like state.

Ice and ice substitutes have made short-term storage and handling of foodstuffs convenient, especially in the context of outdoor grilling. However, while frozen foods can be placed directly on or near a heat source for cooking, neither ice itself nor ice substitutes can be used for direct transfer of food to, and processing of food on, a hot surface.

### BRIEF DESCRIPTION OF THE INVENTION

### Objects of the Invention

The principal object of the invention is to aid in grilling foods by transferring heat away from foods for storage or transport and into foods during cooking. Another object of the invention is to provide lateral support for foods while being grilled. Yet another object of the invention is to compress or shape foods prior to or during grilling.

### SUMMARY OF THE INVENTION

The present invention is a freezer-to-fire “brick” or “puck” made of solid aluminum. These preferred two embodiments are formed from a rectangular solid or an upright cylinder, respectively, with a cavity molded into one end of each. Holes are provided in each for ease of handling.

The present invention also includes processes whereby these embodiments are used to accomplish one or more tasks, including, but not limited to:
supporting food on a cooking surface;
providing a heat ballast in a refrigerated or a cooking environment;
applying supplemental heat during cooking; and
shaping or containing food during cooking.

These and other benefits will be more clearly illustrated in the following detailed description and drawings.

### BRIEF DESCRIPTION OF THE DRAWINGS

FIG. 1 is an isometric view of the first preferred embodiment of the invention.

FIG. 2 is a top view of the first preferred embodiment of the invention.

FIG. 3 is a side view of the first preferred embodiment of the invention. It is also the view of the opposite side of the first preferred embodiment of the invention.

FIG. 4 is an end view of the first preferred embodiment of the invention. It is also the view of the opposite end of the first preferred embodiment of the invention.

FIG. 5 is the bottom view of the first preferred embodiment of the invention.

FIG. 6 is section cut B-B′ of the first preferred embodiment of the invention.

FIG. 7 is section cut A-A′ of the first preferred embodiment of the invention.

FIG. 8 is an isometric view of the second preferred embodiment of the invention.

FIG. 9 is the top view of the second preferred embodiment of the invention.

FIG. 10 is a side view of the second preferred embodiment of the invention. It is also the view of the opposite side of the second preferred embodiment of the invention as well as the front and rear views of the second preferred embodiment of the invention.

FIG. 11 is the bottom view of the second preferred embodiment of the invention.

FIG. 12 is section cut C-C′ of the second preferred embodiment of the invention.

FIG. 13 is an oblique view of an optional additional part for use with the invention, namely, a specialized handle.

FIG. 14 is a depiction of one way the first preferred embodiment of the invention may be used advantageously.

FIG. 15 is a depiction of one way the second preferred embodiment of the invention may be used advantageously.

FIG. 16 is a depiction of another way the second preferred embodiment of the invention may be used advantageously.

### DETAILED DESCRIPTION OF THE INVENTION

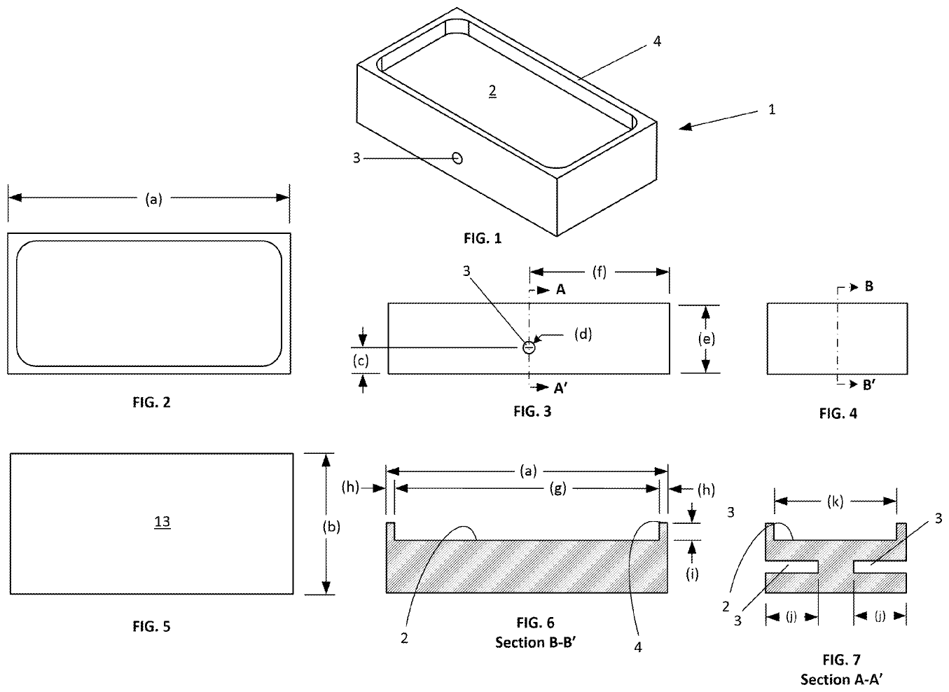

Referring now to the drawings, in which like reference characters refer to like elements among the figures, FIG. 1 is an isometric view of the first preferred embodiment, or “brick” 1, of the invention. Preferably it is cast, forged, or milled (or a combination of these) from aluminum, which provides the best balance of cost, weight, heat conductivity and heat capacity. The amount of metal used to make the brick 1 should be such that its heat gain over a temperature change from freezing to room temperature is equal to the heat of fusion of about four ounces of ice. If aluminum is selected as the metal, the resulting brick size is convenient for the uses described further below.

A cavity 2 is formed in the top of the brick 1 for the purpose of containment or shaping of food during storage or cooking. The cavity 2 creates a lip 4 around the periphery of the top of the brick 1. The cavity 2 may be rounded at the corners as shown for ornamental design. A cylindrical handling hole 3 is formed in the longer side of the brick for handling purposes as explained further below. A mirror image coaxial handling hole 3 is formed in the opposite side.

FIG. 2 is a top view of the first preferred embodiment of the invention. Preferably, the length (a) of the brick is 8″.

FIG. 3 is a side view of the first preferred embodiment of the invention. It is also the view of the opposite side of the first preferred embodiment of the invention. The height (e) of the brick is preferably 2″. The diameter (d) of the handling hole 3 is preferably 11/32″. The centerline (c) of the handling hole 3 is preferably 11/16″ from the bottom edge of the brick on both sides and at the midpoint (f) of each side (4″ from either end). Placing the handling hole at this height and at the midpoint balances the brick on the specialized holder described further below, allowing for ease of handling and placement on a grill.

FIG. 4 is an end view of the first preferred embodiment of the invention. It is also the view of the opposite end of the first preferred embodiment of the invention.

FIG. 5 is the bottom view of the first preferred embodiment of the invention, showing the flat bottom surface 13. The width (b) of the brick is preferably 4″. The volume of metal resulting from the above dimensions is 50.4 in³.

FIG. 6 is section cut B-B′ (from FIG. 4) of the first preferred embodiment of the invention. It shows the cavity 2 having a preferred length (g) of 7½″ and a depth (i) of ½″, leaving a width (h) of ¼″ for the lip 4.

FIG. 7 is section cut A-A′ (from FIG. 3) of the first preferred embodiment of the invention. It shows the cavity 2 having a preferred width (k) of 3½″, and the handling holes 3 having a preferred horizontal depth (j) of 1½″. The volume of the cavity resulting from the above dimensions is 12.7 in³. The ratio of the cavity volume to the metal volume is thus 0.252, or about 25%.

FIG. 8 is an isometric view of the second preferred embodiment, or “puck” 5, of the invention. It is formed from a solid cylinder of metal, again preferably aluminum. As in the first preferred embodiment, the amount of metal used to make the puck 5 should be such that the heat gain over a temperature change from freezing to room temperature is equal to the heat of fusion of about four ounces of ice. If aluminum is selected as the metal, the resulting puck size is convenient for the uses described further below.

A cavity 2 is formed in the top of the puck for the purpose of containment or shaping of food during storage or cooking. The cavity 2 creates a lip 4 around the periphery of the top of the puck. Four horizontal cylindrical handling holes 3 are formed at right angles to each other in the vertical wall of the puck for handling purposes. Each handling hole thus placed balances the puck on the specialized holder described further below, allowing for ease of placement of the puck on a grill.

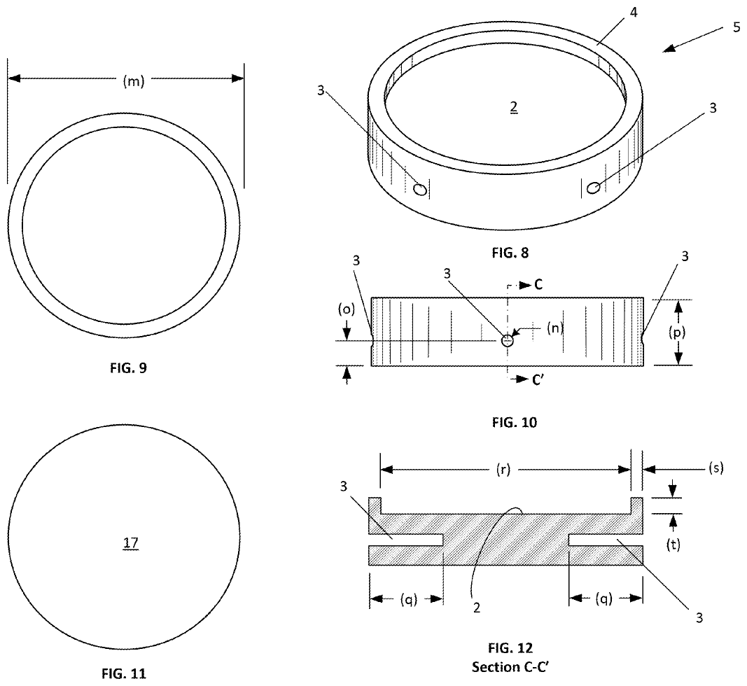

FIG. 9 is the top view of the second preferred embodiment of the invention. Preferably, the diameter (m) of the puck is 6¼″.

FIG. 10 is a side view of the second preferred embodiment of the invention. It is also the view of the opposite side of the second preferred embodiment of the invention as well as the front and rear views of the second preferred embodiment of the invention. The height (p) of the puck is preferably 2″. The diameter (n) of the handling hole 3 is preferably 11/32″. The centerlines (o) of the four handling holes 3 are preferably 11/16″ from the bottom edge of the puck. Placing the handling holes at this height balances the puck on the specialized holder described further below, allowing for ease of handling and placement on a grill.

FIG. 11 is the bottom view of the second preferred embodiment of the invention, showing bottom flat surface 17.

FIG. 12 is section cut C-C′ of the second preferred embodiment of the invention. It shows the cavity 2 having a preferred diameter (r) of 5¾″, and the handling holes 3 having a preferred horizontal depth (q) of 1½″. The height (t) of the lip 4 is ½″, and its width (s) is ¼″. The volume of metal resulting from the above dimensions is 47.8 in³. The volume of the cavity resulting from the above dimensions is 13.0 in³. The ratio of the cavity volume to the metal volume is thus 0.271, or about 27%.

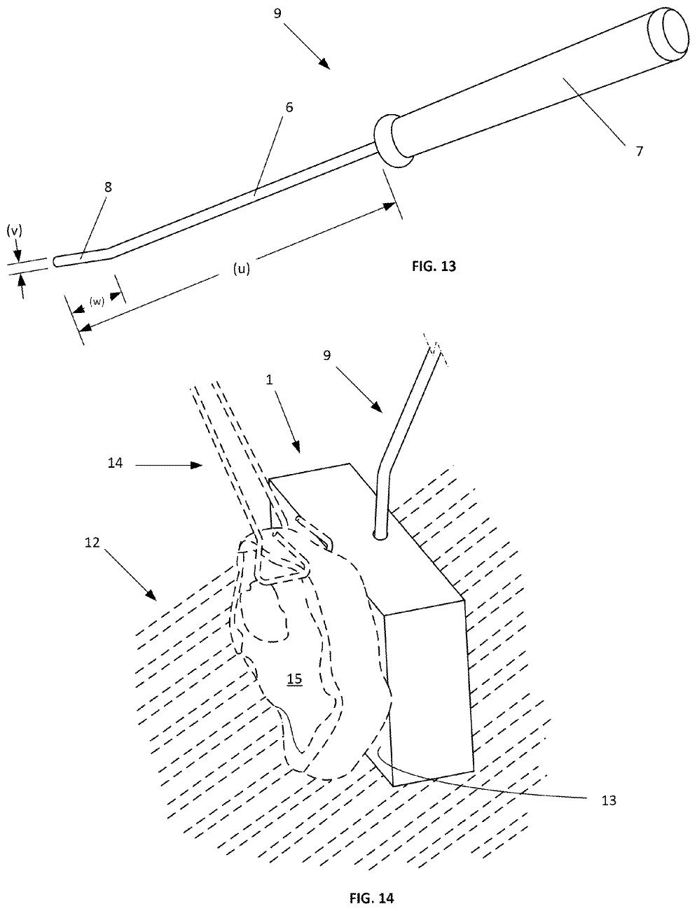

FIG. 13 is an oblique view of a specialized holder 9 for use with both preferred embodiments of the invention. It has a cylindrical metal rod 6 at one end (left in this view) of a preferred length (u) of about 12″ and a diameter (v) of 5/16″. This diameter enables a slip fit into the handling holes 3 of the preferred embodiments of the invention. A handle 7 is provided at the other end, preferably of a non-heat-conductive material for the comfort of the user. Note that the tip 8 on the rod 6 is of approximate length (w) of 2½″ and is offset about 15 degrees from the axis of the rod. Shaped in this manner, the holder can be used to lift either of the embodiments of the invention by inserting the tip into one of the handling holes and twisting the handle so that the tip is angled upward. The weight of the invention then holds it in place on the holder. The user can then place the invention on food or the grill as shown in FIGS. 14-16 or in any other convenient manner.

The specialized holder 9 is inserted at the horizontal balance point of each of the preferred embodiments, as shown in FIGS. 3 and 8. This means that when either of the embodiments is held by the specialized holder, it can be flipped easily, without touching it, to interchange the cavity surface with the flat surface simply by brushing the embodiment against the grill or the food.

FIG. 14 is a depiction of one way the first preferred embodiment of the invention may be used advantageously. Dashed lines indicate environmental structure. The brick 1 is placed on a hot grill 12 using the holder 9 so that the brick's flat bottom surface 13 is vertical. The brick may optionally be preheated on the grill or by being placed directly in the coals. Using tongs 14 (or other common meat handling utensil) a steak 15 is placed vertically against the flat bottom surface 13 of the brick 1 so that the lower edge of the steak can receive direct grilling heat. The steak 15 may rotated with the tongs about a horizontal axis so that the other edges are grilled while it is supported by the brick 1. If the brick 1 has been preheated, the steak is cooked simultaneously on its edge and its flat surface lying against the brick. This shortens grilling time and prevents parts of the meat from being burned or undercooked. Absent the use of this invention in this manner, the edge of a steak will not get the same exposure to grilling heat as its flat sides. A grilling enthusiast can develop special skills using this invention to cook items more thoroughly and evenly, with all sides and edges also having more even warmth when served.

Not shown in this figure is the possibility of using a second preheated brick to support the steak from the other side and cook it from three directions at the same time. Other configurations and usages of this embodiment should now be apparent to a person with cooking skill, and this embodiment and its methods of use are not intended to be limited by this description.

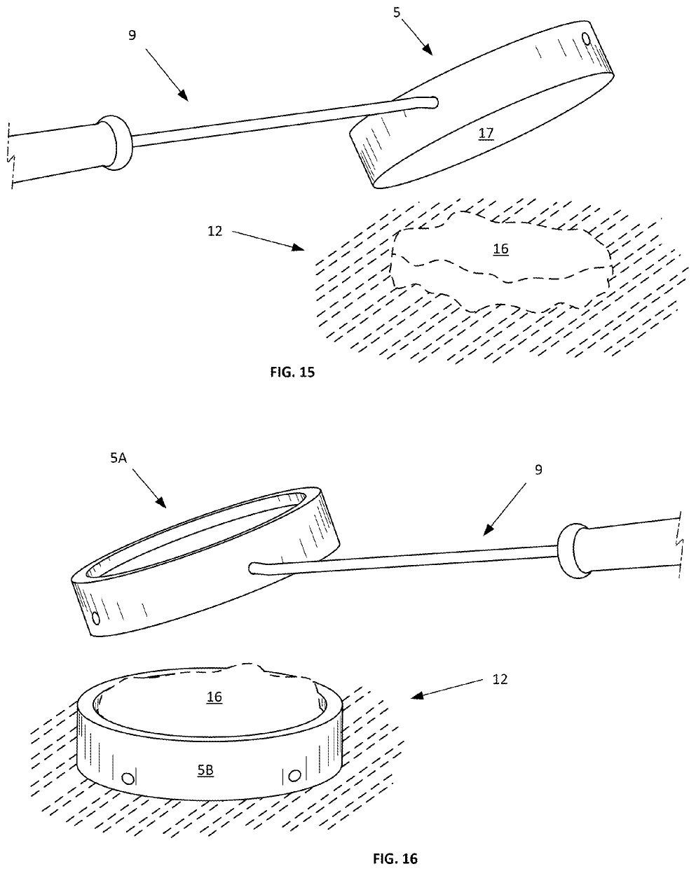

FIG. 15 is a depiction of one way the second preferred embodiment of the invention may be used advantageously. Dashed lines indicate environmental structure. First, puck 5 is preheated to high heat either on a hot grill 12 or by direct placement in coals. A patty of uncooked meat 16 is placed on the grill 12. The heated puck 5 is then placed on top of the patty using the specialized holder 9. The flat bottom surface 17 of the puck 5 is placed directly against the patty so that it will cook simultaneously from the top and the bottom. The puck 5 may also be pressed against the meat with the holder if desired. This greatly shortens grilling time and prevents parts of the meat from being burned or undercooked. The meat also arrives at the table or bun in a uniformly warm condition.

FIG. 16 is a depiction of another way the second preferred embodiment of the invention may be used advantageously. Dashed lines indicate environmental structure. In this instance, two pucks 5A and 5B are used. Puck 5B may be stored in a freezer with a meat patty 16 frozen in it. It may be placed directly on the hot grill 12 for thawing and cooking, or it may be allowed to thaw to room temperature first. Alternatively, the two pucks may first be preheated to high heat. Puck 5B is oriented on the grill 12 with its cavity 2 facing upward and with an uncooked meat patty 16 placed in the cavity. Heated puck 5A is then placed on top of the patty 16 as shown, causing it to take the round shape of the cavity and cooking it from the top as well as the bottom.

Another way of using either of the preferred embodiments of this invention is to keep foodstuffs chilled after they have been removed from refrigeration. An example of this is to put a dip such as cocktail sauce in the cavity of a brick or puck before or after it has been chilled in a refrigerator. The heat capacity of the invention keeps the dip or sauce cold much longer than if it had been served in a dish at room temperature, or even in a chilled dish.

Other configurations and usages of this embodiment should now be apparent to a person with cooking skill, and this embodiment and its methods of use are not intended to be limited by this description.

1. A grilling utensil, comprising:
a unit of solid material comprising:
a top, a bottom, and at least one side;
the solid material having a first volume;
the bottom having a flat surface and the top having a cavity therein;
the cavity having a second volume;
the second volume being no greater than one-half of the first volume; and
the at least one side being perpendicular to the bottom.

2. The utensil of claim 1, wherein:
said unit has at least one handling hole having an axis;
said at least one handling hole is in the at least one side of said unit; and
said axis is parallel to said flat surface.

3. The utensil of claim 2, in which:
said cavity has a rectangular floor parallel to said flat surface and has a cavity length, a cavity width, and a cavity depth;
said at least one side is four sides: a front side, a right side perpendicular to the front side, a back side perpendicular to the right side, and a left side perpendicular to the back side;
the front and back sides have a length, the left and right sides have a width; and
all sides have an equal height.

4. The utensil of claim 3, wherein:
said axis is equidistant between said right side and said left side;
and is at an axis height above said flat surface such that the weight of said unit is balanced on either side of said axis regardless of the orientation of said unit in a vertical plane about said axis.

5. The utensil of claim 3, in which:
said solid material has a heat gain from freezing to room temperature equal to the heat of fusion of between three and five ounces of ice.

6. The utensil of claim 2, in which:
said cavity has a circular floor parallel to said flat surface and has a cavity diameter and a cavity depth;
said at least one side is a single cylindrical side;
the cylindrical side has a height; and
said flat surface is circular and has a diameter.

7. The utensil of claim 6, wherein:
said axis is at an axis height above said flat surface such that the weight of said unit is balanced on either side of said axis regardless of the orientation of said unit in a vertical plane about said axis.

8. The utensil of claim 6, in which:
said solid material has a heat gain from freezing to room temperature equal to the heat of fusion of between three and five ounces of ice.

9. A grilling utensil, comprising:
a unit of solid material comprising:
a top, a bottom, and at least one side;
the bottom having a flat surface and the top having a cavity therein;
the at least one side being perpendicular to the bottom;
at least one handling hole having a hole diameter and an axis parallel to the flat surface;
the axis being at an axis height above the flat surface such that the weight of the unit is balanced on either side of the axis regardless of the orientation of the unit in a vertical plane about the axis; and
a specialized holder having a cylindrical tip having a tip diameter less than said hole diameter.

10. The utensil of claim 9, in which:
said specialized holder comprises a handle at one end and a metal rod at the other;
the metal rod having a rod axis;
said cylindrical tip being at the end of the metal rod, and having a tip axis;
the tip axis being offset about 15 degrees from the rod axis.

11. A method of using the utensil of claim 9, comprising the steps of:
(a) chilling said unit below ambient temperature in a refrigerating device;
(b) inserting said tip into said at least one handling hole;
(c) rotating said unit with said specialized holder so that said flat surface of said unit rests on a horizontal surface; and
(d) placing at least one foodstuff in said cavity.

12. The method of claim 11, wherein:
step (d) comes before step (a); and
said horizontal surface in step (c) is a cooking surface.

13. The method of claim 11, in which:
step (a) is chilling said unit below ambient temperature in said refrigerating device with said flat surface resting on a first horizontal surface within said refrigerating device;
step (b) is replaced by step (d); and
step (c) is removing said unit from said refrigerating device with said specialized holder and placing said unit on a second horizontal surface.

14. A method of using the utensil of claim 9, comprising the steps of:
(a) heating at least one of said units above ambient temperature;
(b) placing a foodstuff on a cooking surface; and
(c) moving at least one of said units with said specialized holder so that said flat surface of said unit rests on said foodstuff.

15. The method of claim 14, in which:
step (a) is heating two of said units above ambient temperature;
step (b) is moving a first of two of said units with said specialized holder so that said flat surface of the first of said units rests on a cooking surface;
step (c) is placing at least one foodstuff in said cavity of the first of said units; and
step (d) is moving a second of two of said units with said specialized holder so that said flat surface of the second of said units rests on said foodstuff.

16. The method of claim 14, in which:
step (b) is using said specialized holder to place said unit on a cooking surface so that said flat surface is perpendicular to said cooking surface; and
step (c) is placing a foodstuff against said unit.

17. The method of claim 15, wherein:
step (b) is moving a first of two of said units with said specialized holder so that said flat surface of the first of said units is perpendicular to a cooking surface;
step (c) is placing at least one foodstuff against said flat surface of the first of said units; and
step (d) is moving a second of two of said units with said specialized holder so that said flat surface of the second of said units rests against said at least one foodstuff.

18. A grilling utensil, comprising:
a unit of solid material comprising:
a top, a bottom, and at least one side;
the solid material having a first volume;
the bottom having a flat surface and the top having a cavity therein;
the cavity having a second volume;
the second volume being no greater than one-half of the first volume; and
the at least one side being perpendicular to the bottom.

19. The utensil of claim 18, in which:
said solid material has a heat gain from freezing to room temperature equal to the heat of fusion of between three and five ounces of ice; and
has at least one handling hole.
